(19) United States
(12) Patent Application Publication
(10) Pub. No.: US 2024/0095778 A1
(43) Pub. Date: Mar. 21, 2024

(54) VIEWABILITY MEASUREMENT IN VIDEO GAME STREAM

(71) Applicant: Bidstack Group PLC, London (GB)

(72) Inventors: Francesco PETRUZZELLI, London (GB); Arseni ANISIMOVICH, London (GB)

(21) Appl. No.: 17/946,244

(22) Filed: Sep. 16, 2022

(51) Int. Cl. G06Q 30/02; A63F 13/61; G06V 20/64

(52) U.S. Cl. CPC G06Q 30/0272; A63F 13/61; G06V 20/64

(57) ABSTRACT

A computer-implemented method includes obtaining a video stream comprising footage of video game play, detecting an instance of the object within an image frame of the video stream using an object detector trained to detect instances of an object within footage of video game play, and comparing the detected instance of the object with a specimen instance of the object to determine a value of a viewability characteristic for the detected instance of the object.

### BACKGROUND OF THE INVENTION

### Field of the Invention

The present disclosure relates to determining a value of a viewability characteristic for an object appearing in a video game stream. The disclosure has particular, but not exclusive, relevance to determining whether an advert appearing within a video game stream satisfies viewability criteria for an impression of the advert to be recorded.

### Description of the Related Technology

The rise in popularity of video games and increasing availability of high-speed internet connections have led to the emergence of video game streaming as a popular pastime. In video game streaming, a potentially large number of viewers stream footage of video game play, either in real time (so-called live streaming) or at a later time. The footage may be accompanied by additional audio or video, such as commentary from the player(s) and/or camera footage showing reactions of the player(s) to events in the video game.

Video game developers are increasingly pursuing revenue streams based on the sale of advertising space within video games. Adverts may for example be presented to a user as part of a loading screen or menu, or alternatively may be rendered within a computer-generated environment during gameplay, leading to the notion of in-game advertising. For example, in a sports game, advertising boards within a stadium may present adverts for real-life products. In an adventure game or first-person shooting game, adverts for real-life products may appear on billboards or other objects within the game environment. In order to facilitate this, a software development kit (SDK) or other software tool may be provided as part of the video game code to manage the receiving of advertising content from an ad server.

Advertisers are typically charged in relation to a number of “impressions” of an advert experienced by video game players. An impression may be recorded whenever an instance of an advert satisfies a set of viewability criteria. Because different players will experience a given video game differently, it is not usually possible to predict a priori the number of impressions that will be experienced by a given player. In order for the advertising revenue model to be applied to in-game advertising, the viewability of an advert may therefore be measured in real time as a video game is played. This functionality may be built into the SDK or other software tool, which may be able to leverage other parts of the video game code to measure viewability at the gaming device, for example using ray-tracing or by reusing data from the graphics processing pipeline. Various factors affect the viewability of an advert, including: (1) the duration of time that the advert is on screen, (2) the size of the advert in relation to the total size of the screen or viewport, (3) the angle from which the advert is viewed, and (4) the proportion of an advert which is visible within the screen or viewport, which depends on whether the advert extends outside the viewport, and whether any portion of the advert is occluded by other objects appearing in the scene.

A single instance of an advert appearing within a video game may lead to hundreds or thousands of impressions of the advert if the video game is streamed. However, the operator of the ad server may not have control or visibility of where or when the video game is streamed, because gamers are typically free to upload a video stream to any streaming platform at any time without informing an advertising service provider or providing access to their gaming device. Therefore, impression counts recorded at the gaming device may not be available for a corresponding video game stream. Furthermore, video game footage may be modified for streaming, for example by overlaying camera footage of the gamer's reactions to events within the game, meaning that even if viewability measurements are available from the gaming device, they may not be reliable in the streaming context.

### SUMMARY

According to aspects of the present disclosure, there are provided a computer-implemented method, a non-transient storage medium carrying instructions for carrying out the method, and a system comprising at least one processor and at least one memory storing instructions which, when executed by the at least one processor, cause the at least one processor to carry out the method. The method includes obtaining a video stream comprising footage of video game play, detecting an instance of the object within an image frame of the video stream using an object detector trained to detect instances of an object within footage of video game play, and comparing the detected instance of the object with a specimen instance of the object to determine a value of a viewability characteristic for the detected instance of the object.

By determining the value of the viewability characteristic directly from the video stream, access to the video game code or gaming device may not be required, in contrast with other methods of viewability testing. Furthermore, any modification to the video game footage, for example adding overlays or insets, is taken into account in the resulting value of the viewability characteristic, ensuring reliable viewability data is obtained from which reliable impression counts can be recorded.

The viewability characteristic may be a proportion of the detected instance of the object visible within the image frame. Determining the value of the proportion of the detected instance of the object visible within the image frame may include determining a transformation relating a geometry of the detected instance of the object to a geometry of the specimen instance of the object, determining a set of pixel positions occupied by the specimen instance of the object when transformed in accordance with the determined transformation and overlaid on the detected instance of the object, and calculating a proportion of pixels of the image frame at the determined set of pixel positions that are occupied by the detected instance of the object. In this way, the known dimensions of the specimen instance of the object are utilized to determine how much of the detected instance of the object is occluded by other objects or lies outside a boundary of the image frame.

In the above example in which the viewability characteristic is a proportion of the detected instance of the object visible within the image frame, calculating the proportion of pixels of the image frame at the determined set of pixel positions that are occupied by the detected instance of the object may include mapping pixels of the specimen instance of the object to pixels of the image frame at the determined set of pixel positions using the determined transformation, and calculating a proportion of the determined set of pixel positions for which a deviation between color values of the pixels of the image frame and color values of the pixels of the specimen instance of the object is less than a threshold value. Performing a pixel-wise color comparison with the specimen instance of the object enables accurate and robust occlusion detection, even for intricate occluding objects. Including the threshold allows for discoloration of pixels due to lighting and other effects within the video game. As an alternative, the object detector may be arranged to generate segmentation data predicting which pixels of the image frame are occupied by the detected instance of the object, in which case the proportion of the pixels of the image frame at the determined set of pixel positions that are occupied by the detected instance of the object may be derived from segmentation data.

The transformation relating the geometry of the detected instance of the object to the geometry of the specimen instance of the object may be a first transformation, and determining the first transformation may include transforming the specimen instance of the object in accordance with a plurality of candidate transformations, and identifying the first transformation as one of the plurality of candidate transformations resulting in a best match between pixels of the transformed specimen instance of the object and pixels of the image frame at matching pixel positions when the transformed specimen instance of the object is overlaid on the detected instance of the object. Comparing pixels between the transformed specimen instance of the object and the detected instance of the object enables the transformation to be determined accurately even if edges, corners, or other key points of the object are not visible within the image frame.

Determining the transformation relating the geometry of the detected instance of the object to the geometry of the specimen instance of the object may include estimating characteristics of a bounding polygon for the detected instance of the object, and determining the transformation by comparing the estimated characteristics of the bounding polygon with characteristics of a bounding polygon for the specimen instance of the object. The characteristics of the bounding polygon may include lengths of sides of the bounding polygon, angles between sides, and distances between sides, all of which may be estimated for example using segmentation data or edge detection methods. Because the shape of the object is known from the specimen instance of the object, only part of the bounding polygon needs to be visible to identify the correct transformation. The method of estimating characteristics of a bounding polygon for the detected instance of the object and comparing with a bounding polygon for the specimen instance of the object may also be used to estimating a proportion of the detected instance of the object appearing within a coordinate range of the image frame.

The viewability characteristics may be a size of the detected instance of the object in relation to a size of the image frame, and determining the size of the detected instance of the object in relation to the size of the image frame may include estimating characteristics of a bounding polygon for the detected instance of the object, and determining the size of the detected instance of the object in relation to the size of the image frame based on the estimated characteristics of the bounding polygon. Alternatively, determining the size of the detected instance of the object in relation to the size of the image frame may include determining a transformation relating a geometry of the detected instance of the object to a geometry of the specimen instance of the object, determining a number of pixels occupied by the specimen instance of the object transformed in accordance with the determined transformation.

The image frame may depict a three-dimensional environment viewed from a perspective of a virtual camera, and the object may have a substantially planar surface. The viewability characteristic may then be a viewing angle between a normal vector to the substantially planar surface and a vector between the virtual camera and a point on the substantially planar surface. Viewing angles may be defined differently for non-planar objects, for example by replacing the normal vector with a predetermined vector indicating of a forward direction with respect to the object.

In an example where the viewability characteristic is a viewing angle, determining the value of the viewing angle may include transforming the specimen instance of the object in accordance with a plurality of candidate transformations, each of the candidate transformations including a respective rotation, and identifying the viewing angle from the respective rotation of one of the plurality of candidate transformations resulting in a best match between pixels of the transformed specimen instance of the object and pixels of the image frame at matching pixel positions when the transformed specimen instance of the object is overlaid on the detected instance of the object. Comparing pixels between the transformed specimen instance of the object and the detected instance of the object enables the value of the viewing angle be determined accurately even if edges, corners, or other key points of the object are not visible within the image frame.

In another example where the viewability characteristic is a viewing angle, determining the value of the viewing angle may include estimating characteristics of a bounding polygon for the detected instance of the object, and determining the viewing angle by comparing the estimated characteristics of the bounding polygon with characteristics of a bounding polygon for the specimen instance of the object. Because the shape of the object is known from the specimen instance of the object, only part of the bounding polygon needs to be visible to identify the correct viewing angle.

The method may further include training the object detector using steps comprising, for a plurality of input image frames, applying a transformation to the specimen instance of the object to generate a transformed instance of the object, inserting the transformed instance of the object into the input image frame to generate a training image frame, and determining associated label data for the training image frame indicating at least a location of the transformed instance of the object within the training image frame. The steps may then include training the object detector using supervised learning with the generated training image frames and associated label data. The object detector may be trained to detect and classify instances of many different objects, and in different types of video game. This may improve the ability of the object detector to generalize. This may be particularly valuable in cases where it is not known a priori which video games a given object will be inserted into.

For at least one of the plurality of input image frames, generating the training image frame may include overlaying an occluding object on the transformed instance of the object and/or applying a distortion effect to the transformed instance of the object. In this way, the robustness of the object detector may be improved. For example, the distortion effect may be selected to mimic known distortion effects within video games, and a range of different occluding objects may be used to mimic types of occluding objects which are expected to appear within video games.

The image frame may be a first image frame, and the method may further include tracking the instance of the object over a plurality of image frames including the first image frame, and aggregating values of the viewability characteristic over the plurality of image frames to determine an aggregated value of the viewability characteristic for the instance of the object. Viewability criteria for determining whether an impression of an object is recorded may depend on the aggregated (for example, accumulated or averaged) value of the viewability characteristic over a sequence of image frames. Tracking the instance of the object may also improve detection accuracy within a given image frame.

The object may change appearance in a predetermined manner between image frames, and comparing the detected instance of the object with the specimen instance of the object comprises synchronizing a timing of the detected instance of the object with a timing of the specimen instance of the object. In cases where the object is a video object or includes a video element, this ensures alike frames of the specimen instance of the object and the detected instance of the object are compared.

The object may be an in-game advert, and the method may include counting an impression of the in-game advert in dependence on the determined value of the viewability characteristic. According to the advertising revenue model, advertisers may pay for a fixed number of impressions of an in-game advert, or may be charged in dependence on how many impressions are recorded. Using the present method, this model may be extended to video game streams, which may be watched by many more viewers than the number of players. To facilitate this, the method may further include determining a number of views of the video stream by users of a streaming service, and determining a total number of impressions of the in-game advert in proportion to the number of views of the video stream by the users of the streaming service and a number of impressions counted in the video stream.

In an example where the object is an in-game advert, the image frame may be a first image frame, and the method may include tracking the instance of the in-game advert over a plurality of image frames including the first image frame, and counting the impression in dependence on determining that the values of the viewability characteristic satisfy a set of criteria for at least a predetermined number of frames.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 schematically shows a system for video game streaming in accordance with examples.

FIG. 2 schematically shows functional components of an impression server in accordance with examples.

FIG. 3 is a flow diagram representing a computer-implemented method of counting impressions of an advert in a video game stream.

FIG. 4 is a flow diagram representing a computer-implemented method of determining a proportion of an object visible within an image frame of a video game stream.

FIGS. 5A-5G illustrate methods of determining viewability characteristics for objects in a video game stream.

FIG. 6 is a flow diagram representing a computer-implemented method of training an object detector to detect adverts in a video game stream.

### DETAILED DESCRIPTION OF CERTAIN INVENTIVE EMBODIMENTS

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further notes that certain examples are described schematically with certain features omitted and/or necessarily simplified for the ease of explanation and understanding of the concepts underlying the examples.

Embodiments of the present disclosure relate to measuring the appearance of an object within a video stream featuring footage of video game play. In particular, embodiments described herein address the difficulty of obtaining reliable viewability data for in-game adverts appearing within a video stream.

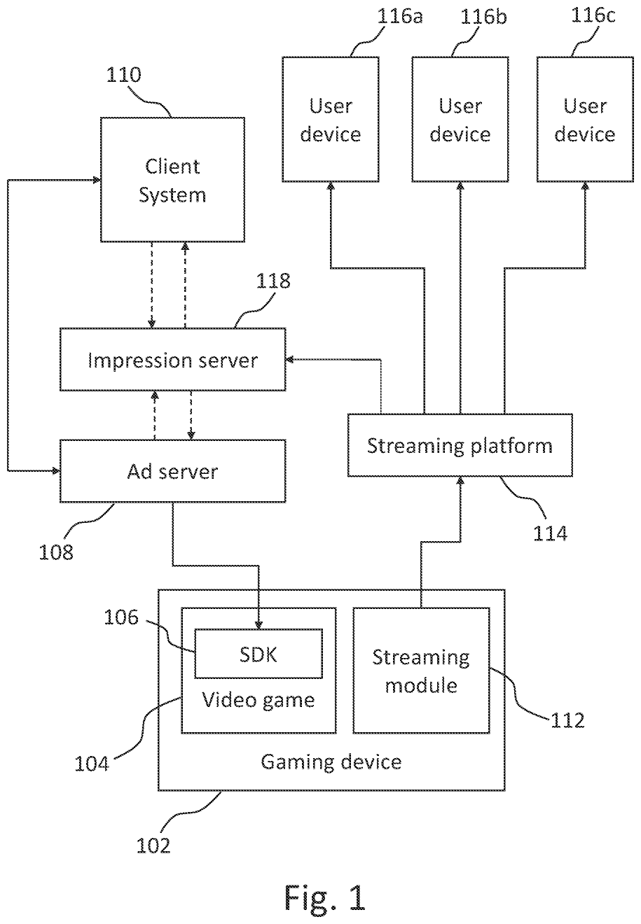

FIG. 1 shows an example of a system including a gaming device 102 arranged for one or more users (referred to hereafter as gamers) to play a video game 104. The gaming device 102 can be any electronic device with processing circuitry capable of processing video game code to output a video signal to a display device in dependence on user input received from one or more input devices. The gaming device 102 may for example be a personal computer (PC), a laptop computer, a tablet computer, a smartphone, a games console, a smart tv, a virtual/augmented reality headset with integrated computing hardware, or a server system arranged to provide cloud-based gaming services to remote users. The gaming device 102 may be arranged to store the video game 104 locally, for example after downloading the video game 104 over a network, or may be arranged to read the video game 104 from a removable storage device such as an optical disc or removable flash drive. The video game 104 may be purchased by a user of the gaming device 102 from a commercial entity such as a games developer, license holder or other entity, or may be obtained for free, via a subscription model, or in accordance with any other suitable revenue model. In any of these cases, the commercial entity may obtain additional revenue by selling advertising space within the video game 104 to advertising entities, either directly or via a third party. For example, a video game developer may allocate particular objects, surfaces, or other regions of a scene within the video game 104 as advertising space, such that advertisements appear within said regions when the scene is rendered during gameplay.

The rendered advertisements may be static images or videos and may be dynamically updated as the user plays the video game 104, for example in response to certain events or certain criteria being satisfied. Furthermore, the rendered advertisements may be updated over time, for example to ensure that the rendered advertisements correspond to active advertising campaigns, and/or in dependence on licensing agreements between commercial entities. The advertisements for rendering are managed at the gaming device 102 by a software development kit (SDK) 106, which facilitates communication between the gaming device 102 and an ad server 106. For example, the ad server 106 may transmit advert data to the gaming device 106 periodically or in response to events at the gaming device 102 or the ad server 106. The ad server 106 may be a standalone server or may be a networked system of servers. In this example, the ad server 106 is operated by a commercial entity responsible for managing the distribution of adverts to gamers on behalf of advertisers, though in other examples an equivalent or similar system may be operated directly by an advertiser. In this example, the ad server 106 receives adverts directly or indirectly from multiple client systems operated by respective advertisers, including client system 110 shown in FIG. 1.

The gaming device 102 includes a streaming module 112 arranged to enable transmission of a video stream featuring footage of the video game 104 being played, directly or indirectly to a streaming platform 114. The video stream may be transmitted to the streaming platform 114 in substantially real-time (for example, to enable a live stream of video game play), or may be transmitted asynchronously from the video game 104 being played, for example in response to user input at the gaming device 102 after the gaming session has ended. The video stream includes a sequence of image frames and may include an associated audio track featuring audio generated by the video game 104. The video stream may further include footage and/or audio of the gamer playing the video game 104, recorded using a camera and microphone. The gamer may for example narrate the gameplay or otherwise share their thoughts to create a more immersive experience for viewers of the video game stream.

The streaming platform 114 may include a standalone server or may be a networked system of servers, and may be operated by a streaming service provider, such as YouTube (RTM), Twitch (RTM) and HitBox (RTM). The streaming platform 114 is arranged to transmit a video stream to user devices 116 (of which three—user devices 116a, 116b, 116c—are shown). The video stream transmitted by the streaming platform 114 may be identical in content to the video stream received from the streaming module 112, or may be modified or processed, for example to ensure certain criteria are satisfied. Depending on the commercial model operated by the streaming service provider, the streaming platform 114 may include additional advertising within the video stream, for example by inserting ad breaks within the video stream. The video stream may be transmitted to the user device 116 as a live stream (substantially in real-time as the video game 104 is played) or may be transmitted to the user devices 116 asynchronously, for example at different times when the user devices 116 connect to the streaming platform 114.

The system of FIG. 1 further includes an impression server 118, which in this example is operated by the same commercial entity as the ad server 108, though in other examples may be operated by a different entity, such as the streaming service provider. In some examples the impression server may be integral to the ad server 108. The impression server 118 is arranged to receive specimen instances of adverts from the ad server 108 or from the client system 110, and to use the specimen instances of the adverts to train an object detector to detect instances of the adverts appearing in a video stream. The impression server 118 is further arranged to detect or identify video streams transmitted by the streaming platform 114 which may include adverts provided by the ad server 108, and to analyze those video streams to detect instances of adverts appearing within the video stream using the trained object detector. The impression server may for example search for metadata of live streams which indicate footage of a particular video game, or may analyze video streams to identify particular video games. Alternatively, manual input may be used to identify relevant video streams.

The impression server 118 is further arranged to determine values of viewability characteristics for the instances of adverts in the video stream, and to generate impression data using the determined values of the viewability characteristics. The impression data may for example indicate a number of impressions, within the received video stream, of each advert provided by the client system 110. The impression server 118 in this example is further able to determine information regarding the number of views of the video stream by user devices 116. Such information is made publicly available for many streaming service providers, though in some examples the operator of the impression server 118 may have a commercial deal with the streaming service to obtain such information, or more nuanced information for example relating to demographics of viewers of the video stream. Using this information, the impression server 118 may determine a total number of impressions of a given advert, which may be transmitted to the ad server 108 and/or the client system 110. The impression server 119 may send additional data to the ad server 108 and/or the client system 110, for example aggregated values of the viewability characteristics for a given video stream.

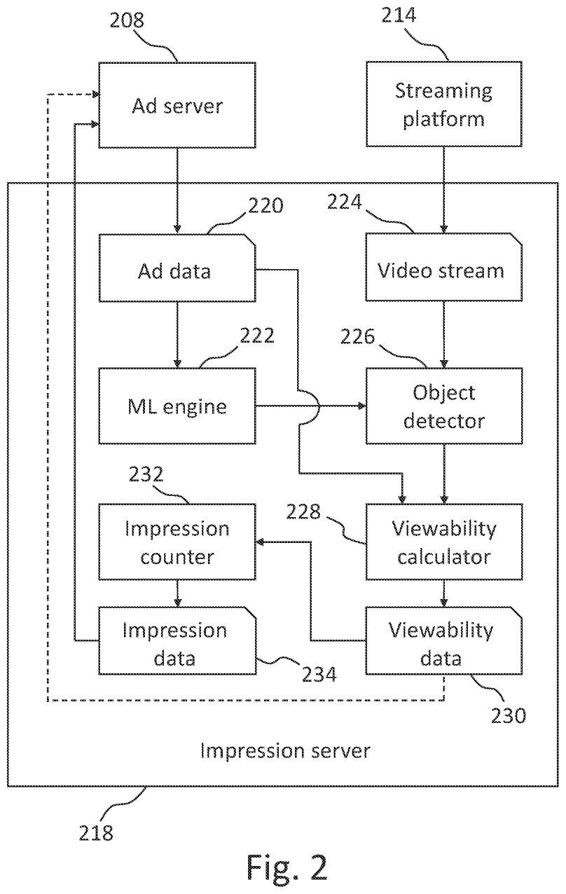

FIG. 2 schematically shows functional components of an example of an impression server 218. The impression server 218 may provide a similar functionality to the impression server 118 of FIG. 1. In this example, the impression server 218 is arranged to receive ad data 220 from an ad server 208, and to receive a video stream 224 from a streaming platform 214. The ad data 220 includes specimen instances of one or more in-game adverts inserted into video games by the ad server 208. Each in-game advert may take the form of an image or a sequence of images for incorporation into a video game environment, for example to be mapped to a surface of an object within the video game environment. A specimen instance of an advert is an image or sequence of image frames of a given size (i.e. a given number of pixels) representing the appearance of the advert at a particular orientation (typically upright and directly towards the viewer, though this is not essential). The ad data 220 may further include metadata such as identifiers for the adverts.

The video stream 224 includes a sequence of image frames featuring footage of a video game being played, along with possibly one or more overlays or insets showing camera footage of the player of the video game. The video game may be a three-dimensional video game, in which case the footage may be the result of a three-dimensional environment being rendered from a perspective of a virtual camera. For each image frame, the virtual camera is allocated a position and orientation (i.e. pose) within the three-dimensional environment, which determines which part of the three-dimensional environment is rendered. The part of the three-dimensional environment rendered within an image frame may be referred to as a scene.

The video stream 224 may have associated metadata such as indicating a frame rate, encoding information, and any other information necessary for the video stream 224 to be played using appropriate video rendering software. The video stream 224 may feature one or more instances of adverts, including in-game adverts. In the present disclosure, an instance of an object may refer to an uninterrupted appearance of the object within a sequence of image frames. For example, an object may appear within a first sequence of image frames, then be occluded or move outside the field of view for a second sequence of image frames, then reappear later in a third sequence of image frames, in which case two instances of the object may be recorded. An instance of an object may therefore span multiple image frames, and may change appearance between those image frames, for example in the case of an animated object.

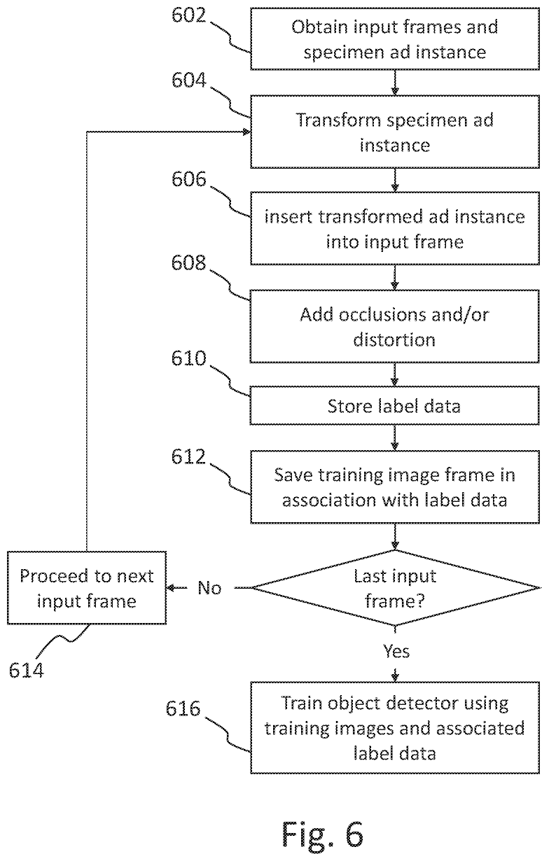

The impression server 218 includes a machine learning engine 222, which is configured to train an object detector 226 to detect instances of adverts within footage of video game play. More specifically, the machine learning engine 222 is arranged to generate training data using the specimen instances of the adverts appearing within the ad data 220, and to use the generated training data to train the object detector 226 using supervised learning. An example of a training method which may be performed by the machine learning engine 222 is described in detail below with reference to FIG. 6.

The object detector 226 may include a neural network model or any other suitable type of object detection model. The object detector 226 may be trained to detect and identify instances of various adverts so that the detected instances can be matched with identifiers provided within the ad data 220. The object detector 226 may be arranged to output a position and dimensions and of a rectangular bounding box for a detected instance of an advert, and/or may be arranged to perform semantic segmentation to predict which pixels of an image frame are occupied by an instance of an object. The output of the object detector 226, referred to hereafter as object detection data, may therefore include one or more of classification data, confidence data, bounding box data, and semantic segmentation data. Suitable object detectors are numerous and well-known in the art—examples are based on You Only Look Once (YOLO) and/or Mask Region-Based Convolutional Neural Network (Mask R-CNN). The object detector 226 may be arranged to process image frames independently, or may be arranged to track an instance of an advert between image frames, for example by employing a recurrent neural network (RNN) or long short-term memory (LSTM) architecture. Other methods of tracking an instance of an object are known, for example using recursive filters to predict a path of the instance of the object between image frames. In cases where tracking is employed, the object detection data may further include a unique identifier for the detected instance of the advert. Tracking an instance of an advert may enable values of viewability characteristics to be aggregated between image frames, and may also improve detection and classification accuracy, particularly if the advert takes the form of a video.

The impression server 218 includes a viewability calculator 228, which is arranged to determine values of one or more viewability characteristics for instances of adverts detected by the object detector 226. In order to do so, the viewability calculator 228 receives object detection data from the object detector 226, along with specimen instances of adverts provided within the ad data 220. In particular, the viewability detector 228 is arranged to compare a detected instance of an advert with a corresponding specimen instance of the object to determine the values of the viewability characteristics, as will be explained in more detail hereinafter.

An example of a viewability characteristic is a proportion of a detected instance of an object which is visible within an image frame. An instance of an object may be partially obscured or occluded by other objects in a scene, or may extend beyond a border of the image frame or viewport. Another example of a viewability characteristic is a proportion of the image frame or viewport occupied by an object, or a size of the object in relation to the total size of the image frame or viewport. Another example of a viewability characteristic is a viewing angle, which for a planar object may be defined as an angle between (i) a vector from a predetermined point on the object to a location of a virtual camera defining a perspective from which the environment is viewed, and (ii) an outward-facing normal vector of the object. The viewability calculator 228 may further be arranged to aggregate values of these viewability characteristics, for example to determine an average or a sum over a sequence of image frames in which the instance of the object is visible. The viewability calculator 228 determines viewability data 230 which may include the raw or aggregated values of the viewability characteristics.

The impression server 218 further includes an impression counter 232, which is arranged to process the viewability data 230 to determine whether to record an impression of an advert. The impression server 218 may receive aggregated viewability data for each detected instance of an advert, or may receive raw viewability data, and may record impressions in dependence on whether viewability criteria are satisfied, for example according to a standard or as agreed with a particular commercial entity. For example, a set of viewability criteria may specify that, for an impression of an advert to be recorded, for at least two seconds (or a corresponding number of image frames), an instance of an advert must have a viewing angle of less than 45 degrees, a size of at least 5% of the area of the image frame, and be at least 50% visible. The impression server 218 generates impression data 234, which in this example is transmitted to the ad server 208. The ad server 208 may report the impression data to a client system (not shown) and/or may use the impression data to control the insertion of adverts into video games, for example when it is determined that a pre-agreed number of impressions have been recorded.

In some examples, the viewability data 230 may be sent to the ad server 208 or to the client system, in addition to the impression data 234 or instead of the impression data 234. By providing this information to the operator of the client system, the advertiser may be provided with more detailed information on how the adverts appeared within the video stream 224, enabling the advertiser to evaluate its own metrics or viewability criteria to count impressions and/or assess the effectiveness of an in-game advertising campaign.

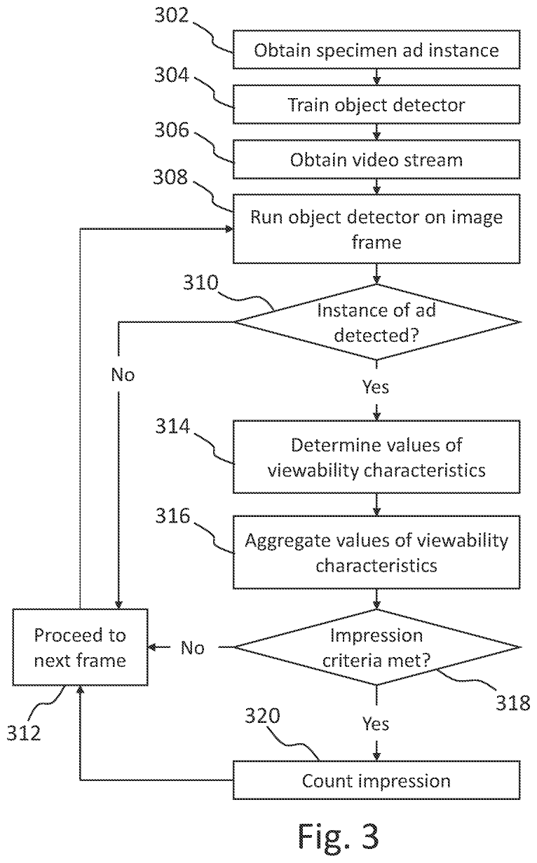

FIG. 3 shows an example of a computer-implemented method which may be performed by a system such as one of the impression servers 118, 218. The method begins with obtaining, at 302, a specimen instance of an advert. The specimen instance of the advert may have a pre-assigned advert-specific identifier, the identifier may be generated as part of step 302, or the identifier may be generated separately. The method proceeds with training, at 304, an object detector to detect instances of the advert within footage of video game play. The object detector may be trained to detect instances of many different adverts, possibly from several different advertisers (though in other cases different instances of an object detector may be trained separately on difference sets of adverts). As will be explained in more detail hereinafter, the object detector is trained to detect instances of the advert at different orientations and under different conditions such as various lighting conditions, in the presence of distortions and occlusions, and so on.

The method continues with obtaining, at 306, a video stream from a streaming platform. The video stream features footage of video game play. As explained above, the video stream may be identified by its metadata or by analysing the video data itself to identify a particular video game in which in-game adverts are known to appear. The method proceeds by running, at 308, the trained object detector on an image frame of the video stream. If it is determined, at 310, that no instance of an advert is present, then the method proceeds, at 312, to the next frame of the video stream and returns to step 308.

If it is determined, at 310, that an instance of an advert is detected, then the method continues with determining, at 314, values of one or more viewability characteristics for the detected instance of the advert, by comparing the detected instance of the object (as identified in object detection data) with a specimen instance of the same advert. At 316, the values of the viewability characteristics are aggregated, for example added to cumulative values for the viewability characteristics over a set of image frames in which the instance of the advert has been detected. Aggregating the viewability characteristics may be facilitated by tracking the instance of the advert using a unique identifier generated by the object detector 308.

The method proceeds with determining, at 318, whether viewability criteria are satisfied by the aggregated values of the viewability characteristics. In an example where values of viewability characteristics are accumulated over the course of multiple image frames, determining whether the viewability criteria are satisfied may include determining whether the accumulated values have reached predetermined thresholds. If the aggregated viewability criteria are not satisfied, then the method proceeds, at 312, to the next frame. If the aggregated viewability criteria are satisfied, then an impression of the advert is counted at 320 and the method then proceeds, at 312, to the next frame. When an impression has been counted for a given instance of an advert, step 320 may be omitted for further image frames containing the same instance of the advert, so that only a single impression is counted.

It will be appreciated that, while in FIG. 3 the steps of object detection, evaluating viewability characteristics, and aggregating values of viewability characteristics, are performed in sequence for each image frame, in other examples each of these operations may be performed for batches of image frames, for example by (i) running the object detector on every image frame, then (ii) determining values of viewability characteristics for every image frame in which an instance of an object is detected, then (iii) aggregating the values of the viewability characteristics for each instance of the object, and finally (iv) counting impressions. The tracking of instances may be performed at the object detection stage or at the aggregation stage.

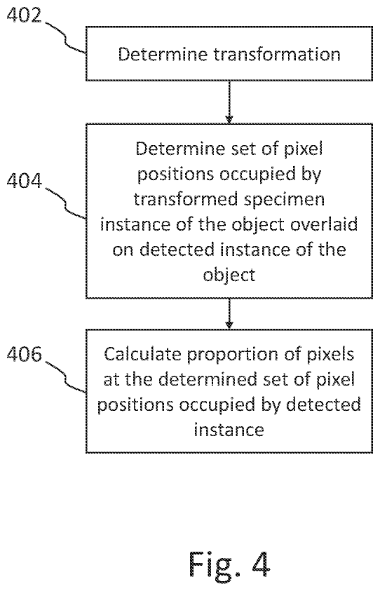

As discussed above, examples of viewability characteristics include viewing angle, the size of an advert compared with the size of the image frame, and the proportion of an advert visible within an image frame. FIG. 4 shows an example of a method by which values of these viewability characteristics may be determined for a given instance of an object detected within an image frame. The method proceeds with determining, at 402, a transformation relating a geometry of the detected instance of the object to a geometry of the corresponding specimen instance of the object. The determined transformation may be a geometrical transformation resulting from a perspective projection or perspective transformation, which governs how an object appears when projected onto a two-dimensional plane from a given perspective. Other transformations are possible in certain situations, for example where a video game uses an orthographic camera as opposed to a perspective camera. The transformation may result in a deformation and/or three-dimensional rotation of the object. Determining the transformation may include determining elements of a transformation matrix having a predetermined structure consistent with a perspective transformation. The viewing angle may be determined from the determined elements of the transformation matrix.

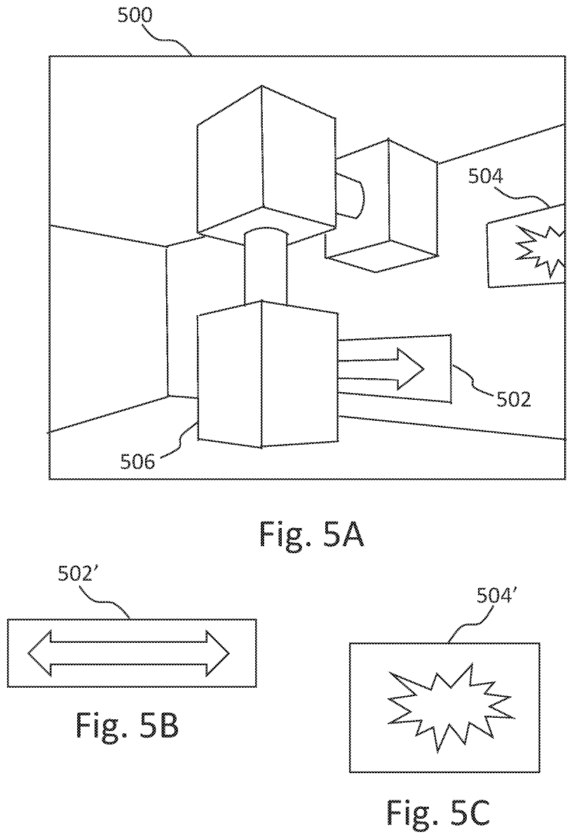

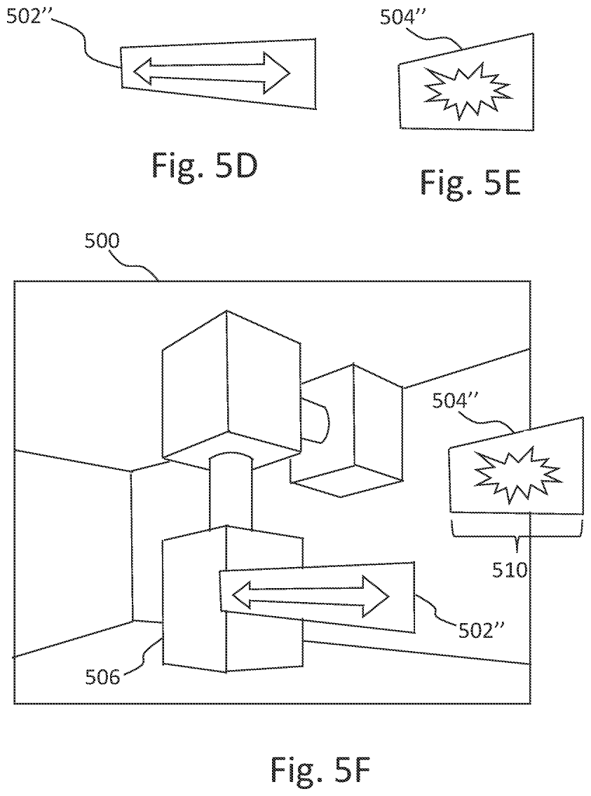

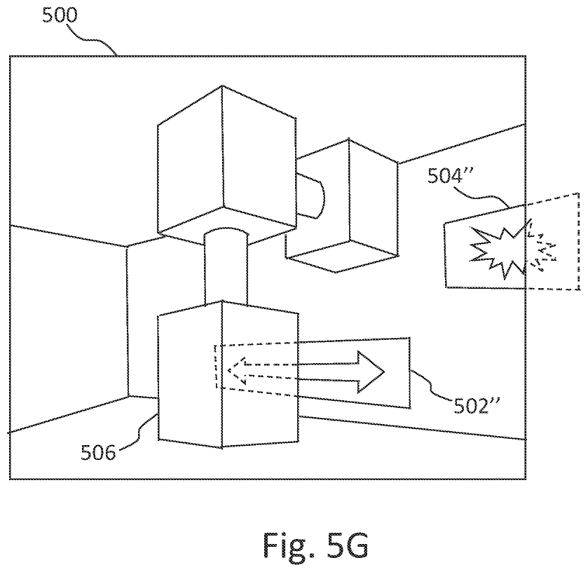

FIG. 5 shows an example of an image frame 500 featuring a scene from a video game. Within the image frame 500, an instance 502 of a first in-game advert and an instance 504 of a second in-game advert are detected. In this example, both in-game adverts are planar images. The detected instance 502 of the first in-game advert is partially occluded by an occluding object 506, whereas the detected instance 504 of the second in-game advert extends beyond a border of the image frame 500. Accordingly, only a portion of each of the detected instances 502, 504 is visible within the image frame 500. FIG. 5B shows a specimen instance 502′ of the first in-game advert, and FIG. 5C shows a specimen instance 504′ of the second in-game advert. The specimen instances 502′, 504′ in this example are rectangular images, though in other examples a specimen instance of an advert or object may have a different shape, may include video elements, and/or may be in the form of a three-dimensional model.

FIG. 5D shows a transformed instance 502″ of the first in-game advert generated by applying a transformation to the specimen instance 502′ of the first in-game advert. It is observed that the geometry of the transformed instance 502′ matches the geometry of the visible part of the detected instance 502 in the image frame 500. In this way, the transformation relates the geometry of the detected instance 502 to the geometry of the specimen instance 502′. FIG. 5E similarly shows a transformed instance 504″ of the second in-game advert generated by applying a transformation to the specimen instance 504′ of the second in-game advert.

Determining a transformation relating a geometry of a detected instance of an object to a geometry of a specimen instance of the object may include transforming the specimen instance of the object in accordance with several candidate transformations, and identifying the transformation which results in a best match between pixels of the transformed specimen instance of the object and pixels of the image frame at matching pixel positions when the transformed specimen instance of the object is overlaid on the detected instance of the object. Each candidate transformation may correspond to a change of geometry resulting from a perspective projection. A set of candidate transformations may first be determined for example based on bounding box dimensions for the detected instance of the object. The range of possible transformations may further be reduced for example if the focal length of the virtual camera is known for the video game. The set of candidate transformations may then be applied in a predetermined or random order until a best pixel match is found. Alternatively, or additionally, candidate transformations may be iteratively modified to generate new candidate transformations, for example by making small test changes and observing the effect on a pixel matching score. By applying this process iteratively, an optimal transformation may be determined which results in a best pixel match between the detected instance of the object and the transformed specimen instance of the object.

An initial candidate transformation may be determined from a predetermined set as discussed above. Alternatively, if the instance of the object has been detected in a previous image frame, then the determined transformation for the previous image frame may be used as an initial candidate transformation, based on the assumption that the transformation is unlikely to change drastically between image frames, particularly if the video stream uses a high frame rate. Using pixel-based matching scores has the advantage that the method can be applied even when edges, vertices, or key points of the object are not visible (for example due to being occluded or lying outside a border of the image frame).

Another method of determining a transformation relating a detected instance of an object to a specimen instance of an object includes estimating characteristics of a bounding polygon for the detected instance of the object, and determining the transformation by comparing the estimated characteristics of the bounding polygon with characteristics of a bounding polygon for the specimen instance of the object. Examples of characteristics of a bounding polygon which may be used for this purpose include positions of corners or vertices within an image frame, positions of sides within an image frame, apparent lengths of sides, and angles between sides. In order to estimate these characteristics, it may only be necessary to identify parts of two or more sides of the detected instance of the object. The sides (or parts thereof) may be identified using segmentation data, for example by identifying a line of pixels delimiting a change of semantic labels, or using edge detection methods within a bounding box for the detected instance of the object. By comparing the estimated characteristics with corresponding characteristics of a bounding polygon for the specimen instance of the object, a transformation matrix may be determined using a system of linear equations, provided sufficient characteristics are estimated that the resulting system of equations has a unique solution.

Returning to FIG. 4, the method continues with determining, at 404, a set of pixel positions occupied by the transformed specimen instance of the object when overlaid on the detected instance of the object. Because the specimen instance of the object has been transformed to have a corresponding geometry to the visible part of the detected instance of the object, the transformed specimen instance of the object can be overlaid on the detected instance of the object such that pixels of the transformed specimen instance correspond to visible pixels of the detected instance of the object. FIG. 5F shows the transformed specimen instance 502″ of the first in-game advert placed at the location of the detected instance 502 of the first in-game advert, and the transformed specimen instance 504″ of the second in-game advert placed at the location of the detected instance 504 of the second in-game advert. In this case, the determined sets of pixel positions are those occupied by the transformed specimen instances 502″, 504″. It is noted that in the case of the transformed specimen instance 504″ of the second in-game advert, some of determined pixel positions lie outside the border of the image frame 500. It is to be noted that the overlaying in FIG. 5F is shown only to illustrate the relevant sets of pixel positions; the actual step of overlaying the transformed specimen instances is not necessarily carried out.

The method concludes with calculating, at 406, a proportion of the pixels at the determined set of pixel positions which are occupied by the detected instance of the object (as opposed to being occluded or lying outside a border of the image frame). This value may be considered to be representative of the proportion of the detected instance of the object which is visible within the image frame. FIG. 5G uses dashed lines to show, for the determined set of pixel positions, which pixels are occluded or lie outside a border of the image frame. The remaining pixels are occupied by the detected instance of the object.

Several methods may be used to determine which pixels at the determined set of pixel positions are occupied by the detected instance of the object. For example, the object detector may be arranged to output segmentation data, predicting which pixels of the image frame are occupied by the detected instance of the object. The segmentation data may be in the form of a segmentation map with pixels corresponding to those of the image frame. The segmentation data may therefore be used to predict which pixels at the determined set of pixel positions are occupied by the detected instance of the object.

Another method of determining which pixels at the determined set of pixel positions are occupied by the detected instance of the object includes mapping pixels of the specimen instance of the object to pixels of the image frame using the determined transformation, and determining which pixel positions exhibit a deviation of color between the image frame and the specimen instance of the object. Pixels of the image frame which are similar in color to pixels of the specimen instance of the object may be determined to be occupied by the detected instance of the object, whereas pixels of the image frame which are significantly different in color to pixels of the specimen instance of the object may be determined not to be occupied by the detected instance of the object. For example, pixel positions for which a deviation between color values of pixels of the image frame and color values of pixels of the specimen instance of the object is less than a threshold value may be determined to be occupied by the detected instance of the object. A deviation between color values being less than a threshold value may imply a pixel color lying within a range or region of a color space. Allowing for the pixel color to lie within a range or region of the color space may account for the possibility of lighting and other effects resulting in pixel colors of the detected instance of the object differing from pixel colors of the specimen instance of the object. The threshold value, and/or the range or region of the color space corresponding to the threshold value, may be predetermined or may be inferred from data, for example by applying different effects to the specimen instance of the object during a configuration stage and analysing how the pixel colors change in response to the applied effects. This may potentially result in different ranges or regions of the color space for different objects and/or different parts of an object. In order to account for objects extending beyond a border of the image frame, pixels lying outside the border of the image frame may be assigned a default color, for example black, white, or a color which is either known not to appear in the specimen instance of the object or is deemed unlikely to appear in the specimen instance of the object. For example, it is observed that color values of pixels within the dashed regions of FIG. 5G differ significantly from color values of corresponding pixels of FIG. 5F (in which the transformed specimen instances 502″ and 504″ have been overlaid to illustrate the mapping of pixels).

In the example of FIG. 5A-5G, it is assumed that the first and second in-game adverts are static images. In other examples, an object may be an animated object, for example a video object. In this case, the method of FIG. 4 may further include the step of synchronizing a timing of the specimen instance of the object with the timing of the detected instance of the object, in order to ensure that like image frames are compared. For video objects, the object detector may determine which frame of the video object is detected within a given image frame of the video stream, such that the timing of the detected instance of the object is determined at the object detection stage.

As explained above, the method of FIG. 4 may be used to determine what proportion of an object is visible within an image frame. The first step 402 may also be used to determine a further viewability characteristic, namely the apparent size of an object in relation to the size of the image frame. For example, by transforming the specimen instance of the object to have a matching geometry to the detected instance of the object, the number of pixels occupied by the specimen instance of the object may be counted and divided with the number of pixels in the image frame.

FIG. 6 shows an example of a method of training an object detector, such as the object detector 226 of FIG. 2, to detect an in-game advert within a video stream featuring footage of video gameplay. The method includes obtaining, at 602, a sequence of input image frames featuring footage of a video game being played, along with a specimen instance of the in-game advert. The video game may be identical or of a similar visual style and genre to a video game in which the in-game advert may be inserted. The method proceeds with transforming, at 604, the specimen instance of the advert to modify a geometry of the specimen instance of the object. The transformation may be a random transformation of a suitable type (for example, corresponding to a perspective projection, a rotation, a scaling, and/or a translation), or may be selected from a predetermined set. Transformations which result in the specimen instance being too large or too small within the image frame (for example according to viewability criteria), or having a viewing angle outside a predetermined range (for example 0 to 90 degrees) may be prohibited or discarded.

The method continues with inserting, at 606, the transformed specimen instance of the advert into the input image frame, to generate a training image frame. For example, the transformed specimen instance may be overlaid on the input image frame at a random or predetermined position such that at least part of the transformed specimen instance is visible within the training image frame. The position may be selected independently of the transformation, or the steps 604 and 606 may be performed together, for example by performing a perspective projection to insert the specimen instance of the advert into the input image frame at a consistent position and geometry.

The method continues with optionally adding, at 608, occlusions and/or distortions to the training image frame, or at least the inserted instance of the object, for example to partially obscure the inserted instance of the object. The occlusions may be randomly generated or may be chosen to be similar to occluding objects expected within a video game. A range of different types of occluding objects may be used, from solid blocks to fine-detailed occluding objects such as clouds of particles, ordered or random grids, branches of trees, and so on. The distortions may include blur (e.g. Gaussian blur and/or motion blur), heat haze, shadow, lighting effects, random fog, global color shift, color jitter, any other visual effect which may be expected within a video game. The distortion may further involve applying image compression noise to the training image frame to mimic noise resulting from compression performed by a video codec Applying a range of types of distortion and occlusion to the training image frame may improve the robustness of the object detector in the presence of distortions or occlusions within a video game. The distortions of step 608 may be applied stochastically, for example with each type of distortion being applied with a respective probability. The respective probabilities may be chosen in dependence on how often the corresponding effects are observed in a video game, which may be determined empirically by observing instances of video game being played. In this way, unwanted bias in the training dataset can be mitigated. It will be appreciated that steps 604-606 can be performed in any order.

The method continues with storing, at 610, label data indicating at least a location of the transformed specimen instance of the advert in the training image frame. The label data may further include ground truth bounding box parameters and/or ground truth segmentation data indicating which pixels of the training image frame are occupied by the transformed specimen instance of the advert. It is to be noted that because the specimen instance of the advert has been transformed and inserted programmatically, reliable ground truth information can be readily ascertained. The label data may further include classification data for identifying the in-game advert.

The method continues with saving, at 612, the generated training image frame in association with the generated label data. The method then proceeds, at 614, to the next input image frame in the sequence. For the next input image frame, a new transformation and position for the specimen instance of the advert may be determined independently from the transformation and position in the previous frame, or may be made dependent on the previous frame, for example to simulate the in-game advert moving through an environment. This approach may be advantageous in particular if the advert includes a video advert and/or if the object detector is arranged to track the advert between image frames. Some training image frames may be generated in which no in-game advert appears, to provide negative training examples. Furthermore, several instances of the in-game advert, or several different in-game adverts, may be inserted into some input image frames.

The method continues with training, at 616, the object detector using supervised learning with the generated training images and associated label data. It will be appreciated that a range of training techniques may be used to improve the efficiency and efficacy of the training method. In a typical example, trainable parameter values of the object detector are updated using gradient descent or a variant thereof to optimize a value of an objective function, which in this case characterizes an error between predictions of the object detector and corresponding ground truth values indicated within the label data.

The method of FIG. 6 has the advantage that the only necessary inputs are a specimen instance of an advert and footage of a video game being played. Using only these inputs, a large volume of training data can be generated relatively quickly, covering a wide range of relevant scenarios. Nevertheless, in some examples, training data may be generated by accessing video game code and adding adverts or objects into a video game in a more realistic way. This approach may result in a more accurate object detector for the specific video game or type of video game, though access to video game code for a large number of video games may be necessary to achieve comparable generalization characteristics, which may be impracticable.

At least some aspects of the examples described herein with reference to FIGS. 1-6 comprise computer processes performed in one or more processing systems and/or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

The above embodiments are to be understood as illustrative examples. Further embodiments are envisaged. For example, the systems and methods described herein are not limited to measuring adverts within video games, but may be used more generally for management of digital content in video games or other computer-generated scenes, such as in the metaverse, which may be subject to streaming. Accordingly, objects detected and analyzed according to the disclosed methods may be two-dimensional or three-dimensional, static or animated. In the case of a three-dimensional object, the specimen instance of the object may be a static or animated three-dimensional model of the object, as opposed to a two-dimensional image or sequence of images as discussed above.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A system comprising at least one processor and at least one memory storing instructions which, when executed by the at least one processor, cause the at least one processor to carry out operations comprising:
obtaining a video stream comprising footage of video game play;
detecting, using an object detector trained to detect instances of an object within footage of video game play, an instance of the object within an image frame of the video stream; and
comparing the detected instance of the object with a specimen instance of the object to determine a value of a viewability characteristic for the detected instance of the object.

2. The system of claim 1, wherein:
the viewability characteristic is a proportion of the detected instance of the object visible within the image frame; and
determining the value of the proportion of the detected instance of the object visible within the image frame comprises:
determining a transformation relating a geometry of the detected instance of the object to a geometry of the specimen instance of the object;
determining a set of pixel positions occupied by the specimen instance of the object when transformed in accordance with the determined transformation and overlaid on the detected instance of the object; and
calculating a proportion of pixels of the image frame at the determined set of pixel positions that are occupied by the detected instance of the object.

3. The system of claim 2, wherein calculating the proportion of pixels of the image frame at the determined set of pixel positions that are occupied by the detected instance of the object comprises:
mapping pixels of the specimen instance of the object to pixels of the image frame at the determined set of pixel positions using the determined transformation; and
calculating a proportion of the determined set of pixel positions for which a deviation between color values of the pixels of the image frame and color values of the pixels of the specimen instance of the object is less than a threshold value.

4. The system of claim 2, wherein the transformation is a first transformation, and determining the first transformation comprises:
transforming the specimen instance of the object in accordance with a plurality of candidate transformations; and
identifying the first transformation as one of the plurality of candidate transformations resulting in a best match between pixels of the transformed specimen instance of the object and pixels of the image frame at matching pixel positions when the transformed specimen instance of the object is overlaid on the detected instance of the object.

5. The system of claim 2, wherein determining the transformation comprises:
estimating characteristics of a bounding polygon for the detected instance of the object; and
determining the transformation by comparing the estimated characteristics of the bounding polygon with characteristics of a bounding polygon for the specimen instance of the object.

6. The system of claim 2, wherein the operations comprise estimating characteristics of a bounding polygon for the detected instance of the object,
wherein determining the proportion of the detected instance of the object visible in the image frame comprises estimating a proportion of the detected instance of the object appearing within a coordinate range of the image frame by comparing the estimated characteristics of the bounding polygon with characteristics of a bounding polygon for the specimen instance of the object when transformed in accordance with the determined transformation.

7. The system of claim 1, wherein:
the viewability characteristic is a size of the detected instance of the object in relation to a size of the image frame; and
determining the size of the detected instance of the object in relation to the size of the image frame comprises:
estimating characteristics of a bounding polygon for the detected instance of the object; and
determining the size of the detected instance of the object in relation to the size of the image frame based on the estimated characteristics of the bounding polygon.

8. The system of claim 1, wherein:
the viewability characteristic is a size of the detected instance of the object in relation to a size of the image frame; and
determining the size of the detected instance of the object in relation to the size of the image frame comprises:
determining a transformation relating a geometry of the detected instance of the object to a geometry of the specimen instance of the object; and
determining a number of pixels occupied by the specimen instance of the object transformed in accordance with the determined transformation.

9. The system of claim 1, wherein:
the image frame depicts a three-dimensional environment viewed from a perspective of a virtual camera;
the object has a substantially planar surface; and
the viewability characteristic is a viewing angle between a normal vector to the substantially planar surface and a vector between the virtual camera and a point on the substantially planar surface.

10. The system of claim 9, wherein determining the viewing angle comprises:
transforming the specimen instance of the object in accordance with a plurality of candidate transformations, each of the candidate transformations including a respective rotation; and
identifying the value of the viewing angle from the respective rotation of one of the plurality of candidate transformations resulting in a best match between pixels of the transformed specimen instance of the object and pixels of the image frame at matching pixel positions when the transformed specimen instance of the object is overlaid on the detected instance of the object.

11. The system of claim 9, wherein determining the value of the viewing angle comprises:
estimating characteristics of a bounding polygon for the detected instance of the object; and
determining the viewing angle by comparing the estimated characteristics of the bounding polygon with characteristics of a bounding polygon for the specimen instance of the object.

12. The system of claim 1, wherein the operations further comprise training the object detector using steps comprising:
for a plurality of input image frames:
applying a transformation to the specimen instance of the object to generate a transformed instance of the object;
inserting the transformed instance of the object into the input image frame to generate a training image frame; and
determining associated label data for the training image frame indicating at least a location of the transformed instance of the object within the training image frame; and
training the object detector using supervised learning with the generated training image frames and associated label data.

13. The system of claim 12, wherein for at least one of the plurality of input image frames, generating the training image frame comprises overlaying an occluding object on the transformed instance of the object and/or applying a distortion effect to the transformed instance of the object.

14. The system of claim 1, wherein the image frame is a first image frame, the operations further comprising:
tracking the instance of the object over a plurality of image frames including the first image frame; and
aggregating values of the viewability characteristic over the plurality of image frames to determine an aggregated value of the viewability characteristic for the instance of the object.

15. The system of claim 1, wherein:
the object changes appearance in a predetermined manner between image frames; and
comparing the detected instance of the object with the specimen instance of the object comprises synchronizing a timing of the detected instance of the object with a timing of the specimen instance of the object.

16. The system of claim 1, wherein:
the object is an in-game advert; and
the operations include counting an impression of the in-game advert in dependence on the determined value of the viewability characteristic.

17. The system of claim 16, wherein the operations include:
determining a number of views of the video stream by users of a streaming service; and
determining a total number of impressions of the in-game advert in proportion to the number of views of the video stream by the users of the streaming service and a number of impressions counted in the video stream.

18. The system of claim 16, wherein the image frame is a first image frame, the operations comprising:
tracking the instance of the in-game advert over a plurality of image frames including the first image frame; and
counting the impression in dependence on determining that the values of the viewability characteristic satisfy a set of criteria for at least a predetermined number of frames.

19. A computer-implemented method comprising, using one or more processors:
obtaining a video stream comprising footage of video game play;
detecting, using an object detector trained to detect instances of an object within footage of video game play, an instance of the object within an image frame of the video stream; and
comparing the detected instance of the object with a specimen instance of the object to determine a value of a viewability characteristic for the detected instance of the object.

20. One or more non-transient storage media comprising instructions which, when executed by the one or more processors, cause the one or more processors to carry out operations comprising:
obtaining a video stream comprising footage of video game play;
detecting, using an object detector trained to detect instances of an object within footage of video game play, an instance of the object within an image frame of the video stream; and
comparing the detected instance of the object with a specimen instance of the object to determine a value of a viewability characteristic for the detected instance of the object.
